(19) United States
(12) Patent Application Publication
(10) Pub. No.: US 2025/0127320 A1
(43) Pub. Date: Apr. 24, 2025

(54) CARPET AND ADHERED CARPET PAD FROM RECYCLED CARPET

(71) Applicant: Aladdin Manufacturing Corporation, Calhoun, GA (US)

(72) Inventors: Harlan Morris, Calhoun, GA (US); Erika Moreno, Calhoun, GA (US); Carlos Carrillo, Calhoun, GA (US); Anthony Cascio, Calhoun, GA (US)

(21) Appl. No.: 18/919,787

(22) Filed: Oct. 18, 2024

Related U.S. Application Data
(60) Provisional application No. 63/592,239, filed on Oct. 23, 2023.

(51) Int. Cl. A47G 27/02; B32B 5/02; B32B 5/26; B32B 37/24

(52) U.S. Cl. CPC A47G 27/025; A47G 27/0281; B32B 5/02; B32B 5/26; B32B 37/24; B32B 2260/021; B32B 2260/046; B32B 2262/02; B32B 2305/22; B32B 2307/744; B32B 2471/02

(57) ABSTRACT

The present invention relates to a carpet or carpet tile made with a pad adhered to a facecloth. The pad may be formed from light particles that would otherwise be considered waste when a carpet is ground and elutriated. The particles may comprise short fibers, any dust and dirt that had not been cleaned from the carpet prior to grinding, and some particles of an adhesive. The adhesive used to adhere the pad to the face cloth may be a latex or a polymeric adhesive. The heavy particles from the elutriation may be used as a filler in the adhesive.

The present invention relates to a carpet or carpet tile made with a pad adhered to the underside. The pad and the adhesive used to secure the pad to the griege product may be formed from particles that would otherwise be considered waste when a used carpet is ground and elutriated. The particles may comprise short polymer fibers, any dust and dirt that had not been cleaned from the carpet prior to grinding, and some particles of the cured latex and/or polymeric adhesives from the ground carpet, along with particles of the primary backing.

### BACKGROUND

Carpets, carpet tiles, and rugs may be made from a face cloth comprising yarns tufted through at least one backing. In some embodiments, a pad may be adhered to the carpet, carpet tile, or rug. The pad may take the place of a separate underlay. A carpet or carpet tile with an adhered pad may not need an underlay since the adhered pad will act the same as an underlay to cushion the feel of the carpet or carpet tile, from the surface, such as a subfloor.

Installing a carpet, carpet tile, or rug with an adhered pad may eliminate the need for a separate underlay thereby reducing the cost and complexity of installation.

In some embodiments, underlays have been made of clean polymer fibers that have been recovered from elutriating carpets. However, that requires separating the clean filaments from dirt, dust, and small particles of latex or other components that may be entrained with the desired polymer fibers. The processing for that final separation to produce clean polymer fibers is complex, costly, and still produces a waste stream that is discarded.

In many cases, the carpets and carpet tiles that are selected for recycling have been homogenous. That is to say that when mixtures of carpets and carpet tiles have been selected for recycling, they are separated into batches that have similar components. One selection may be carpets and carpet tiles that have nylon piles where the recycled nylon is used to make another nylon carpet or carpet tile. One method of reclaiming only the nylon from the pile yarn is to shear the pile away from the backing and then grind the nylon to produce clean filaments for use in a pad. This wastes the remainder of the used carpet, which will contain the primary backing and any other backings such as a pre-coat, a skip coat, and a pad.

Similarly, another selection may be carpets and carpet tiles that have polypropylene piles where the polypropylene is used to make another polypropylene carpet or carpet tile. However, this sorting is usually inefficient and is not entirely accurate. In that, a carpet that has a nylon pile may have a polypropylene primary backing and a polyester backing. In these prior art methods, care must be taken to then separate out the components that are not nylon when making a new nylon carpet or carpet tile.

Similarly, carpets or carpet tiles containing natural fibers such as cotton, jute, and wool have been removed from the process since they have not been considered in making a recycled polymer carpet or carpet tile.

Common shredding and elutriation processes for carpets, carpet tiles, and rugs first separates heavy material from lighter material. The heavier material is denser and contains some polymer fibers from the backing along with larger particles of latex, or any other adhesive such as a hot melt adhesive. These particles may also still be adhered to the primary backing and any other backings from the used carpet. The heavier material from the elutriation has traditionally been discarded since separating particles of latex and/or hot melt adhesive from any remaining fibers is difficult and costly.

The lighter material is less dense and contains much of the face fibers. This stream may also include some portion of the backing and some portion of dust and dirt. In this, the portion of the backing may be only components of the backing that have been separated from any adhesive and are therefore similar in nature to the pile fibers in that they are light enough to elutriate with the pile filaments.

The lighter portion has traditionally been further processed to remove the dust, dirt, and any remaining backing material so that the resulting stream will contain only polymer fibers that are reduced to lengths that are generally less than 0.5 centimeters.

This processing may involve additional elutriation and/or other processes such as washing and fluid separation mechanisms, such as using the densities of materials to separate them while in water. While this additional processing does produce clean polymer fibers, it may remove some desired polymer fibers along with material that is not recyclable, such as latex particles. This may take away up to 50% of the lighter portion leaving only a small portion of the initial carpet to be recycled.

The clean stream of polymer fibers may then be incorporated into an underlay. The underlay may be laid down on a surface, which may be a subfloor, with a carpet or rug placed atop it. The underlay then provides a cushion or padding to soften the feel of the carpet or rug.

These prior art methods of recycling mixtures of carpets and carpet tiles do not optimally utilize the carpets or carpet tiles.

WO 1998/036114 discloses, “Disclosed is a recycling process for complex textile structures, such as floor or wall coverings, consisting in: selectively sorting the materials to be recycled so as to obtain a homogenous mixture of the materials to be processed; filamentation of said materials to form a mixture of fibers of varying lengths. During this filamentation process, the non-fibrous components constituting a portion of the base structure can be eliminated; incorporation into the fibrous mixture of any additives that may be required to manufacture the final product; formation of a lap from the fibrous mixture obtained; heat treatment of the newly formed lap in order to fuse a portion of the fibrous constituents of the mixture or to polymerize an additive, this heat treatment being performed by placing the lap between two conveyors permeable to air, inside a chamber subjected to a hot inflow; cooling of the newly formed lap.”

Australian Patent Application No. 2013206077 discloses, “A method of making a carpet backing layer by passing used carpet through a disintegrator removing latex granules from the disintegrated product and feeding the fibrous portion of the product to a non-woven layer building machine. The carpet product so produced is a needle punched web which has been cross-lapped to form a backing layer. A new carpet is made from the backing web made by joining it to an upper decorative layer.”

These prior art methods do not address what to do with other portions of the ground carpet, carpet tiles, or rugs. For example, the heavy stream will contain particles of adhesive along with attached bits of fiber. Similarly, the prior art does not address what to do with carpets and carpet tiles that have adhered pads. The adhered pads may be of a heavy, dense polymer material, or it may be a light fibrous material. Therefore, there exists a need for a carpet, carpet tile, or rug that has an adhered pad that contains all of the components of a shredded recycled carpet without the need for additional processes from shredding and elutriation, along with a method to produce such a carpet, carpet tile, or rug.

### BRIEF SUMMARY

To this aim, the inventions taught and disclosed here relate to creating a carpet, carpet tile, or rug that has an adhered pad that contains not only clean fibers but also dirt, dust, and small particles of latex or other components. In this, the fibers may contain a mixture of polymer fibers along with natural fibers.

In a first independent aspect, the invention relates to a carpet or carpet tile, comprising: a facecloth comprising a front and a back; a pad comprising filaments, secured to the back of the facecloth; an adhesive comprising a filler; wherein the filaments in the pad are comprised of first polymer fibers; wherein the filler is comprised of second polymer fibers attached to particles of a binder, wherein the binder is selected from the group consisting of a latex and a polymeric adhesive; and wherein a portion of the first polymer fibers originate from the same source as the second polymer fibers.

In a second independent aspect, the invention relates to a method of making a carpet or carpet tile with an adhered pad, comprising: shredding and elutriating a carpet, carpet tile, or rug and separating the ground components into a first stream and a second stream; air laying the first stream to form a pad; adding the second stream to an adhesive; providing a face cloth; and securing the pad to the face cloth with the adhesive.

In a third independent aspect, the invention relates to a carpet underlay, comprising: a pad layer comprising a plurality of filaments; a non-skid layer comprising a plurality of fibers wherein each of the plurality of fibers is secured to at least one binder particle; and wherein a portion of the plurality of filaments originate from the same source as the plurality of fibers.

Descriptions of these inventions will be defined in the appended independent claims, while preferred embodiments are defined in the dependent claims.

### BRIEF DESCRIPTION OF THE DRAWINGS

With the intention of better showing the characteristics of the invention, herein after, as an example without any limitative character, some preferred embodiments are described, with reference to the accompanying drawings, wherein:

FIG. 1 illustrates a prior art method of shredding and elutriating carpet.

FIG. 2 illustrates an improved method of shredding and elutriating carpet according to the inventions disclosed and taught herein.

### DETAILED DESCRIPTION

Applicant has devised ways to reduce the processing of carpet waste streams during recycling to make a carpet or carpet tile that has a binding layer and a pad that May be adhered to a carpet, carpet tile, or rug.

Some prior art methods of recycling carpets and carpet tiles are done by grinding the used carpet and elutriating the ground pieces. Elutriation may separate the ground pieces into a lighter stream and a heavier stream where the lighter stream is composed of fibers from the pile and the heavier stream is composed of fibers still attached to particles of the adhesive, where the adhesive is a cured latex or a cooled hot melt adhesive.

In some of these processes, a secondary step of purifying the lighter stream has been performed. However, Applicant has found that the secondary step of purifying the lighter stream is not necessary when preparing a carpet pad that may be adhered to a carpet or carpet tile.

Also, in some of the prior art methods of recycling carpets, carpet tiles and rugs, the heavy stream may be discarded. However, Applicant has found that this secondary stream may be used as a filler in making an adhesive that may be used for securing the pad to the primary backing which contains a tufted pile.

Also, in the prior art methods of recycling carpets and carpet tiles, the types of carpets have frequently been sorted such that a predominance of a single type of polymer fiber is used to make a new carpet of a similar fiber. However, Applicant has found that sorting is not necessary when the elutriated components are used in making a pad and as a filler in a binding agent such as a latex or a hot melt adhesive.

The methods and techniques disclosed and taught herein may be applied to any carpet, carpet tile, or rug that contains fibers, such as but not limited to yarns of bulked continuous filaments or staple fibers of polyolefins, polyesters, or polyamides, natural fibers, and combinations thereof.

The methods and techniques disclosed and taught herein may be applied to any carpet that contains a latex, such as but not limited to an acrylic or SBR latex.

The methods and techniques disclosed and taught herein may be applied to any carpet that contains a hot melt polymer adhesive such as polyesters such as PET and/or coPET, and polyolefins such as polypropylene and/or polyethylene.

The differences from the prior art methods will be described and compared to the methods of the present inventions.

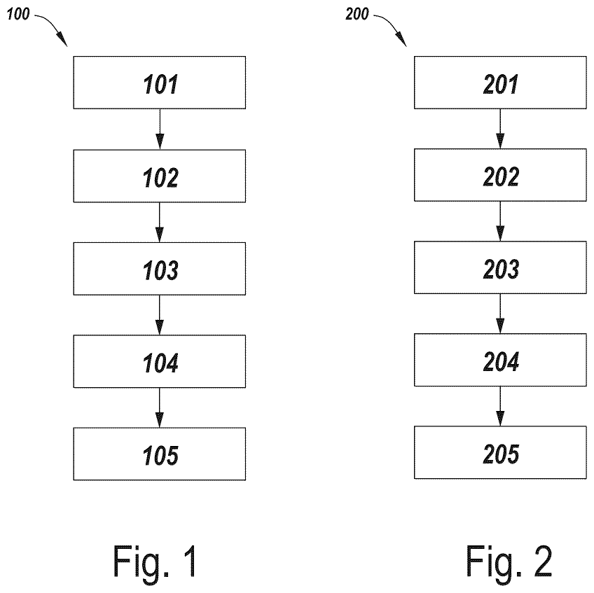

FIG. 1 illustrates the prior art method of preparing a portion of fibrous polymeric material from a carpet.

A carpet to be recycled is provided in Step 101. This carpet to be recycled has an initial weight and may be from carpets, carpet tiles, and/or rugs. This should not contain other flooring components such as pad material, such as rebond, or tack strips or nails. It has been preferred that carpets and carpet tiles not have an adhered pad. It has usually been preferred that carpet seam tape, dirt, dust, and other matter that may be accumulated from normal wear be removed before the carpet is processed.

In this step 101, materials that are not qualified to be recycled are removed. That is, a carpet piece that has adhered rebond would be manually removed from the process. Similarly, carpet tiles that have stains or contain undesirable compositions will also be removed and discarded.

Step 102 illustrates that the carpet to be recycled is shredded and introduced into an elutriation system that will separate particles into streams.

Step 103 illustrates that the heavy stream is separated from the light stream. The heavy stream may be processed in ways known to those skilled in the art and familiar with known techniques. This has predominantly been to discard this stream or to provide it to an entity that is not going to use it to make new carpet.

Step 104 illustrates that the light stream may be further processed to separate clean polymeric fibers from dust, dirt, and other matter. The dust, dirt, and other matter may be processed in ways known to those skilled in the art and familiar with known techniques, but has usually been discarded.

Step 105 illustrates that the purified light stream may be air laid to form a batt. The batt may be needled or thermobonded to a desired thickness and density for a pad.

Applicant's improved method is illustrated in FIG. 2.

A stream of mixed carpets, carpet tiles, and/or rugs to be recycled are provided in Step 201. This mixed stream to be recycled has an initial weight and may be from carpets, carpet tiles, and/or rugs. These should not contain other flooring components such as rebond, or tack strips or nails. The incoming stream may include carpet seam tape, adhered pad material, dirt, dust, and other matter along with stains that may be accumulated from normal wear.

As noted, Applicant's preferred method is to accept all types of carpet, carpet tiles, and rugs together. This means that the streams of recycled flooring material will consist of many different types of polymers and natural fibers that were in the carpets, carpet tiles, and rugs as the pile fibers, the primary backing, latex, polymeric adhesives, filler, any secondary backings, and any adhered pad material, along with dust, dirt, and any other components that may be held in carpets, carpet tiles, and rugs through normal wear and use.

Step 202 illustrates that the mixed stream to be recycled is shredded and introduced into an elutriation system that will separate particles into streams of recycled flooring material.

An optional step (not illustrated in FIG. 2) may be to treat the ground particles to remove or eradicate any biological components such as fungi, bacteria, and viruses. This optional step may be done after Step 202, or at any other time in this process.

Step 203 illustrates that the heavy stream is separated from the light stream of the recycled flooring material. The heavy stream is directed towards a process to use it as an additive to a bonding agent, which may be a latex or a hot melt adhesive.

In Step 203, the heavy stream will contain particles of the backings of the stream of mixed carpets. These may be particles of latex that still contain fibers, and particles of polymeric adhesives that still contain fibers. The ratio of latex with fibers to polymeric adhesive with fibers may range from 99 parts latex with fibers to 1 part polymeric adhesive with fibers, to 1 part latex with fibers to 99 parts polymeric adhesive with fibers. The latex may be any type of latex used in carpets and carpet tiles, such as but not limited to an acrylic or SBR latex. The polymeric adhesive may be any type of polymeric adhesive found in carpets and carpet tiles, such as but not limited to polyesters such as PET, coPET, polypropylene, polyethylene, polyurethane, and similar.

The heavy stream may also contain padding material from the stream of mixed carpets. Some carpets and carpet tiles have a dense thermoplastic laminate on their bottom surfaces that may provide weight and dimensional stability. In other cases, carpets and carpet tiles may have a lightweight fibrous material applied as a pad. In those cases, the light fibrous material will elutriate with the light stream.

The heavy stream may be added as a filler to an adhesive. In some embodiments, the adhesive may be a latex. In other embodiments, the adhesive may be a hot melt adhesive.

Step 204 illustrates that the entirety of the light stream may be air laid to form a pad. The density of the pad may be configured by air laying a thickness of the light stream having a known weight, and then needling or otherwise compressing the thickness to a specific height to provide a desired density. In some embodiments, a bonding agent may be added to bond the components of the pad together. This may be a thermobonding agent that will melt and infuse throughout the pad together when heat is applied. The pad may then be cooled to set the thermobonding agent such that the pad is cohesive and will not separate or tear.

Step 205 illustrates that the pad may then be secured to a bottom side of a carpet or carpet tile face. The face material may comprise a primary backing with a yarn tufted therethrough. The face yarn may be any material used for carpet or carpet tile face yarn such as but not limited to polyamides, polyesters, polyolefins, or their combinations. The face yarn may also be spun natural fibers such as wool or cotton. The face yarn may also be combinations of natural and synthetic materials. In a preferred embodiment, the face yarn may be a polyamide such as nylon, a polyolefin such as polypropylene, or a polyester such as PET.

The primary backing may be any material that is used as a primary backing. In a preferred embodiment, the primary backing may be a woven or nonwoven polypropylene, PET, or polyethylene-nylon blend.

In this step 205, the back of the face material may be coated with the adhesive formed from the step 203 of processing the heavy stream. That is to say that the non-tufted side of the face material may be coated with a latex or a polymeric adhesive such as a hot melt polymer. The latex or polymeric adhesive will contain the heavy stream as described in that step 203.

The carpet or carpet tile may be processed to ensure that the adhesive will properly secure the tuft binds and to provide strength against delamination. The carpet or carpet tile may also be processed to set the latex or polymeric adhesive in ways that are known to those skilled in the art. That is to say that the latex may be cured in an oven, and the polymeric adhesive may be chilled.

Once the carpet or carpet tile is formed in this way, the pad made from recycled carpet, carpet tile, or rug, may be the bottom layer of the article that may be placed on the surface, which may be the subfloor of wood, wood composite, concrete, cement or any other subfloor material known to those skilled in the art. The adhered pad does not need any additional support or any underlay to provide a cushion beneath it.

In another envisioned embodiment, some portion of the heavy stream may be mixed with a binding agent to act as a non-skid layer. This may be an additional process in Step 203.

One exemplary embodiment of this may be to mix some, or all, of the heavy stream with polyurethane. This may be applied either to the back of a tufted facecloth where no pad is to be used, or to the back of a pad. It may be applied as a sheet, in strips, dots, or rills. That is to say that in one embodiment, where a carpet face back is to be coated with a non-skid layer then the mixture of the heavy stream with a binding agent may be applied directly to the back surface of the facecloth. This will need to provide sufficient delamination strength and tuft binding strength. In this embodiment, the facecloth with a non-skid layer may be laid directly on a floor, or it may be laid atop a pad. The non-skid layer will prevent it from moving.

In another embodiment, the heavy stream mixed with a binding agent may be applied to one, or both sides of a pad. If the pad is free-standing, the non-skid layer may be applied to both sides. Alternatively, if the pad is attached to the facecloth as is illustrated in Step 205, the mixture of the heavy stream and the binding agent may be applied to the bottom of the pad to form the non-skid layer.

Applicant envisions that all of the recycled stream of carpet, carpet tiles, and rugs will be processed and used in the creation of new carpet or carpet tiles. Applicant envisions that the weight percent of the new carpet or carpet tiles will be between 50% and 80% from the recycled stream of carpet, carpet tiles, and rugs. As may be seen then, the components of a single piece of carpet, carpet tile, or rug may contribute between 50% and 80% of the weight of a new piece of carpet, carpet tile, or rug. That is to say that a single piece of a carpet, carpet tile, or rug that is processed in the ways disclosed and taught herein may be used in the creation of a new carpet, carpet tile, or rug.

Some new materials will need to be used in the new carpets or carpet tiles. It is envisioned that between 50% and 20% by weight of the new carpets or carpet tiles will be from the face material and the adhesive.

### CONCLUSION

The present invention is in no way limited to the herein above-described embodiments. On the contrary many such products may be made using recycled carpets, carpet tiles, and/or rugs to form an adhered pad to a new carpet or carpet tile.

1.-18. (canceled)

19. A carpet or carpet tile, comprising:
a facecloth comprising a front and a back;
a pad comprising filaments, secured to the back of the facecloth;
an adhesive comprising a filler;
wherein the filaments in the pad are comprised of first polymer fibers;
wherein the filler is comprised of second polymer fibers attached to particles of a binder, wherein the binder is selected from the group consisting of a latex and a polymeric adhesive; and
wherein a portion of the first polymer fibers originate from the same source as the second polymer fibers.

20. The carpet or carpet tile of claim 19, wherein the pad comprises dust, and dirt.

21. The carpet or carpet tile of claim 20, wherein the first polymer fibers comprise fibers selected from the group consisting of polyamides, polyolefins, polyesters, and combinations thereof.

22. The carpet or carpet tile of claim 21, wherein the pad comprises a thermobonding agent.

23. The carpet or carpet tile of claim 22, wherein a density of the pad is configurable.

24. The carpet or carpet tile of claim 23, wherein the facecloth comprises a yarn comprising a bulk continuous filament comprising a polymer, wherein the polymer is selected from a group consisting of a polyamide, a polyolefin, a polyester, or combinations thereof.

25. A method of making a carpet or carpet tile with an adhered pad, comprising:
shredding and elutriating a carpet, carpet tile, or rug and separating the ground components into a first stream and a second stream;
air laying the first stream to form a pad;
adding the second stream to an adhesive;
providing a face cloth; and
securing the pad to the face cloth with the adhesive.

26. The method of making a carpet or carpet tile of claim 25, wherein the first stream comprises polymeric fibers, dust, and dirt.

27. The method of making a carpet or carpet tile of claim 26, wherein the method further comprises thermobonding the air laid first stream.

28. The method of making a carpet or carpet tile of claim 27, wherein the second stream is comprised of particles of a shredded latex with attached fibers or a shredded polymeric adhesive with attached fibers.

29. The method of making a carpet or carpet tile of claim 28, wherein the adhesive is a latex or a polymeric hot melt adhesive.

30. The method of making a carpet or carpet tile of claim 29, wherein the first stream has an average density that is less than that of the second stream.

31. A carpet underlay, comprising:
a pad layer comprising a plurality of filaments;
a non-skid layer comprising a plurality of fibers wherein each of the plurality of fibers is secured to at least one binder particle; and
wherein a portion of the plurality of filaments originate from the same source as the plurality of fibers.

32. The carpet underlay of claim 31, wherein the pad layer comprises dust and dirt.

33. The carpet underlay of claim 31, wherein a density of the plurality of filaments is less than a density of the plurality of fibers.

34. The carpet underlay of claim 33, wherein the non-skid layer comprises a cured latex.

35. The carpet underlay of claim 33, wherein the non-skid layer comprises a cooled hot melt adhesive.

36. The carpet underlay of claim 35, wherein the non-skid layer comprises polyurethane.

37. The carpet underlay of claim 36, wherein the plurality of filament comprises polymers selected from the group consisting of polyamides, polyolefins, polyesters, and combinations thereof.

38. The carpet underlay of claim 37, wherein the pad layer comprises a thermobonding agent.
